(19) United States
(12) Patent Application Publication
(10) Pub. No.: US 2014/0205806 A1
(43) Pub. Date: Jul. 24, 2014

(54) ARRANGEMENT FOR JOINING A SILICONE PART TO AN ADHESIBLE PART

(71) Applicant: ATON Systems GmbH, Meerbusch (DE)

(72) Inventor: Marcel MEYER, Brilon (DE)

(73) Assignee: ATON Systems GmbH, Meerbusch (DE)

(21) Appl. No.: 14/158,895

(22) Filed: Jan. 20, 2014

(30) Foreign Application Priority Data
Jan. 18, 2013 (DE) 102013000890.5

(51) Int. Cl. B32B 7/12; B32B 37/14

(52) U.S. Cl. CPC B32B 7/12; B32B 37/14
USPC 428/156; 156/60

(57) ABSTRACT

An arrangement for joining a silicone part to an adhesible part, with an intermediate element which is joined on a first surface to the silicone part and is bonded on a second surface to an adhesible part, the first surface having an adhesive structure with micro-undercuts which are cast with the silicone part and form a micromechanical positive fit between the silicone part and the intermediate element, and a joining method.

### TECHNICAL FIELD

The invention relates to an arrangement for joining a silicone part to an adhesible part, of the kind that is needed in order to produce a silicone sealing collar.

### BACKGROUND

While a silicone part consisting of a silicone elastomer can be surface-activated by means of plasma treatment, so that it can be bonded, a bonded joint of this kind does not have sufficient strength for numerous practical applications. The object of the invention is therefore to provide a joint between a silicone part and an adhesible part that offers satisfactory strength for practical purposes.

### SUMMARY

This object is achieved in accordance with the invention by an arrangement for joining a silicone part to an adhesible part, with an intermediate element which is joined on a first surface to the silicone part and is bonded on a second surface to an adhesible part, the first surface having an adhesive structure with micro-undercuts which are cast with the silicone part and form a micromechanical positive fit between the silicone part and the intermediate element. Hence, in accordance with the invention, the connection of the silicone part to the adhesible part is not made by means of an adhesive connection acting on the silicone part, but directly by means of a micromechanical positive fit between the silicone material of the silicone part and the intermediate element, which has a special adhesive structure on its contact surface to the silicone material. The intermediate element thus constitutes an adapter and is bonded on a second surface, which is easily adhesible, to an adhesible part, so that a firm connection is formed between the silicone part and the adhesible part.

The micro-undercuts are preferably configured irregularly. Typical dimensions of the micro-undercuts, such as length or depth on the one hand, and cross-sectional area on the other, can in each case be distributed randomly about a mean value or average value, such as in accordance with a Gaussian distribution.

The silicone part generally consists of a silicone elastomer, such as an organic polysiloxane, which also includes silicone elastmomers that constitute a composite material, e.g. with a thermoplastic material. The silicone elastomer may also be silicone rubber. Silicone copolymers are also encompassed.

It is preferably contemplated that the first surface of the intermediate element is cast in a fluid-tight manner with the silicone part. It is then convenient for no fluid to be able to pass through, along the first surface or transversely thereto.

The intermediate element may be bonded on the second surface to a rigid or flexible adhesible component, which may be a fabric material.

The first surface may have microstructural projections forming micro-undercuts.

Alternatively or in addition, the first surface may have microstructural indentations forming micro-undercuts.

The first surface may include fabric or special knitted material, such as terry cloth, Velcro®, suede, Kevlar® or Armatex®.

It may be contemplated that the intermediate element consists of neoprene (chloroprene rubber), which may be coated with an adhesive layer of fabric or special knitted material to form the first surface.

The invention preferably contemplates that there are an average of at least 100, 1,000, 5,000 or 10,000 micro-undercuts per cm² arranged on the first surface. In order to increase the strength, it may be contemplated that the silicone part, the intermediate element and optionally also the adhesible part are sewn together, and the seams may be sealed.

The silicone part may be a silicone sealing collar, especially for a drysuit for diving, wherein the adhesible part may be a neck, arm or leg part of a drysuit, which must be provided with a water-tight joint to the silicone sealing collar.

The intermediate element may be strip-shaped, wherein the first surface may be a first strip surface and the second surface may be a second strip surface opposite the first strip surface.

Alternatively, the arrangement may be such that the intermediate element is strip-shaped, while the first surface is formed by a first portion of a first strip surface of the intermediate element and the second surface is formed by a second portion of the first strip surface of the intermediate element adjacent to the first portion, wherein a second strip surface, opposite the first strip surface either remains free or is used for other joining purposes. In an arrangement of this kind, the silicone part and the adhesible part are located adjacent to one another on one and the same strip surface of the intermediate element, which in this case should preferably be water-tight and have sufficient mechanical strength.

This invention further relates to an arrangement for joining a silicone part to an intermediate element which is joined on a first surface to the silicone part and is bondable on a second surface to an adhesible part, the first surface having an adhesive structure with micro-undercuts which are cast with the silicone part and form a micromechanical positive fit between the silicone part and the intermediate element, for the creation of an arrangement in accordance with the invention for joining a silicone part to an adhesible part.

This invention further relates to a method for joining a silicone part to an intermediate element which is joined on a first surface to the silicone part and is bondable on a second surface to an adhesible part, the first surface having an adhesive structure with micro-undercuts which are cast with the silicone part, thus forming a micromechanical positive fit between the silicone part and the intermediate element, for the creation of an arrangement in accordance with the invention for joining a silicone part to an adhesible part.

In order to form an arrangement in accordance with the invention for joining a silicone part to an adhesible portion, the intermediate element is bonded to an adhesible part.

### BRIEF DESCRIPTION OF THE DRAWINGS

The invention will now be explained by describing a worked embodiment, reference being made to a drawing, in which

FIG. 1 shows a schematic section view of an arrangement in accordance with the invention for joining a silicone part to an intermediate element and a part bonded to the latter.

FIG. 2 shows a schematic view, partially in section, of a sealing collar of silicone in accordance with the invention with an intermediate element for joining to a drysuit.

FIG. 3 shows the sealing collar alone,

FIG. 4 shows the intermediate element alone.

FIGS. 5 and 6 show various views of the sealing collar joined to the intermediate element.

### DETAILED DESCRIPTION

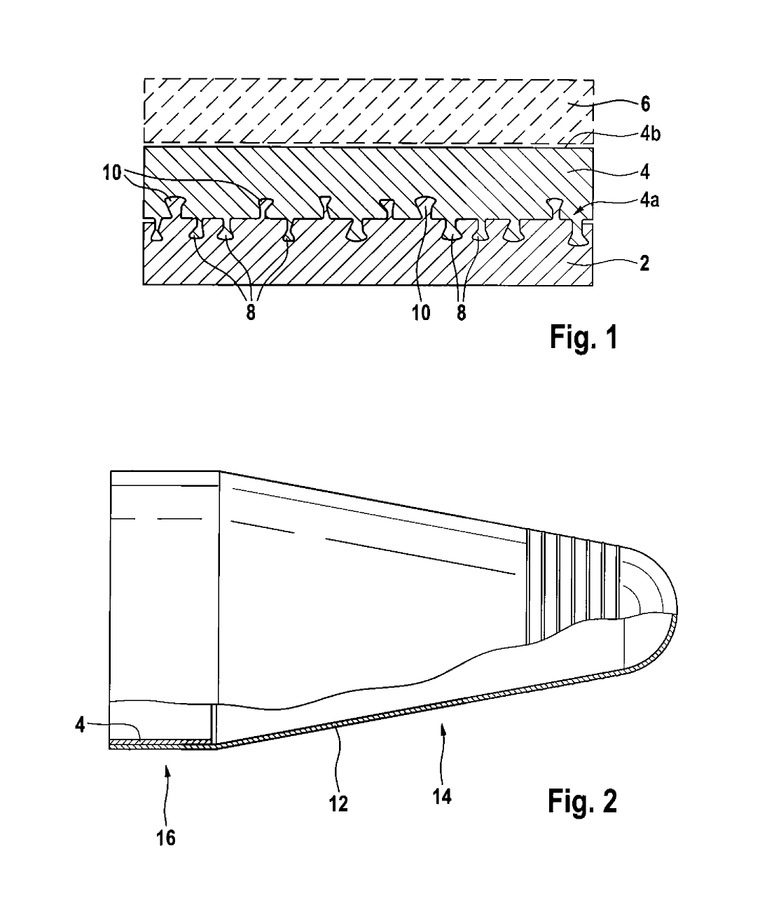

FIG. 1 schematically illustrates an arrangement in accordance with the invention for joining a silicone part 2 to an intermediate element 4. The intermediate element 4 is joined on a first surface 4a to the silicone part 2 and consists of an adhesible material, so that it can be bonded on a second surface 4b to an adhesible part 6 (indicated by dashed lines). The first surface 4a has an adhesive structure with micro-undercuts. The micro-undercuts may be formed by microstructural projections 8 of the intermediate element 4, for example in that the intermediate element has a fabric surface or lamination of a fibrous fabric or special knitted material such as terry cloth, velcro, suede, Kevlar or Armatex. The projections may consist of the material of the intermediate element or of a different material. They may be applied to the intermediate element or may be produced by processing the intermediate element or during the production of the intermediate element. Alternatively or in addition, the first surface 4a may be provided with microstructural indentations 10, which form micro-undercuts, which can likewise be achieved by lamination to a fabric surface or by processing or in the course of production, such as by creating open pores.

On the first surface 4a, there are an average of at least 10, 100, 500, 1,000, 5,000 or 10,000 micro-undercuts per cm². A typical dimension of the projections 8 and/or indentations 10, such as diameter or length or depth, is preferably less than 1 mm, 0.5 mm, 0.1 mm, 0.05 mm or 0.01 mm.

The silicone part 2 is cast with the intermediate element 4, or the intermediate element 4 is cast into the silicone part 2, depending on whether the silicone part is a moulded or dip-cast part. The liquid or flowable silicone material flows around or into the micro-undercuts of the first surface 4a, the projections on the first surface forming the micro-undercuts becoming completely or partially embedded in the silicone material and/or the indentations forming the micro-undercuts becoming completely or partially filled by the silicone material.

After the silicone material has cured, the silicone part 2 is firmly joined to the intermediate element 4 in a micro-positive fit. Before, at the same time as or after the silicone part 2 is joined to the intermediate element 4, the intermediate element may be bonded to the second surface 4b with an adhesible part 6. If the intermediate element, as the invention preferably contemplates, is made of neoprene or chloroprene rubber, bonding to a further neoprene part or to a fabric material is possible with no difficulty.

In order to enhance the bonding strength, the silicone part 2 may be sewn to the intermediate element 4, the intermediate element 4 to the adhesible part 6 or all three parts together. The seams may be sealed in a water-tight manner.

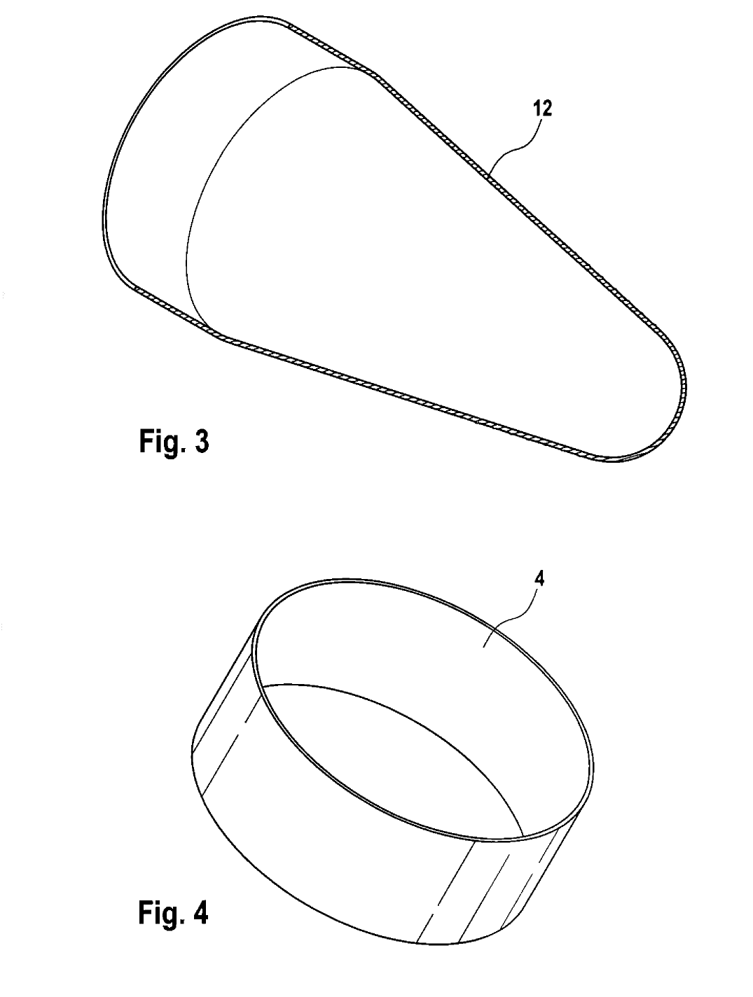

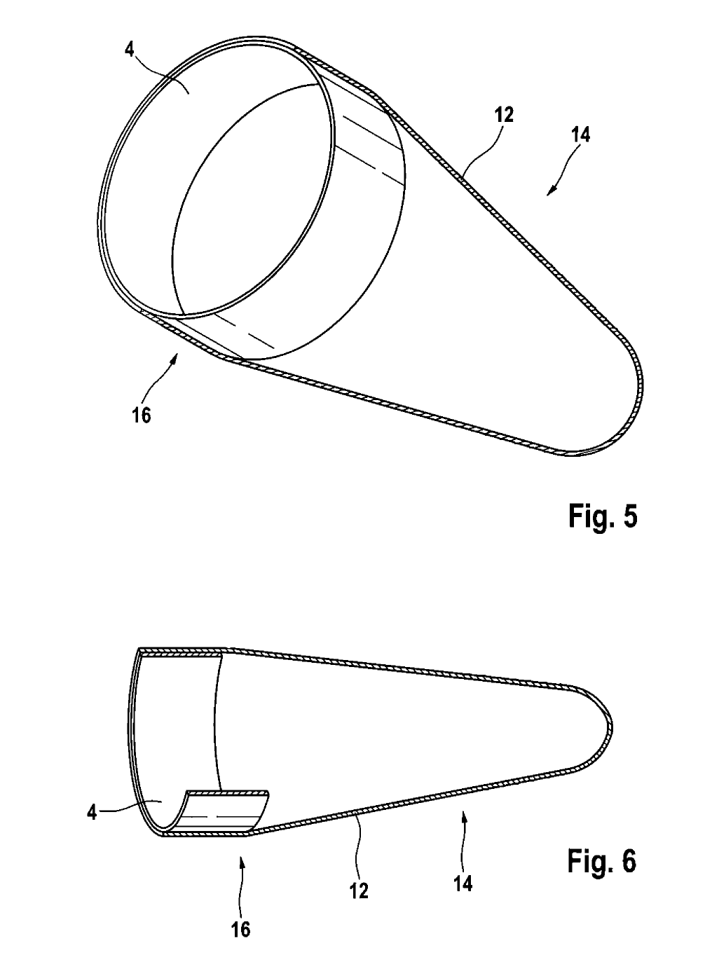

FIGS. 2 to 6 show a partially cut view of a silicone sealing collar 12 and views of an intermediate element, for attachment to a sleeve of a diving suit, in order to provide a flexible seal in the region of a diver's wrist. The silicone sealing collar 12 has a hand portion 14 and a cylindrical sealing portion 16. Inside the sealing portion 16, the silicone sealing collar 12 is provided on its inside with an intermediate element 4, which is joined by means of a micromechanical positive fit, as described, to the outer silicone material, which forms the hand portion 14.

### LIST OF REFERENCE NUMERALS

2 silicone part

4 intermediate element

4a first surface

4b second surface

6 adhesible part

8 projection

10 indentation

12 silicone sealing collar

14 hand portion

16 sealing portion

1. An arrangement for joining a silicone part to an adhesible part, with an intermediate element which is joined on a first surface to the silicone part and is bonded on a second surface to an adhesible part, the first surface having an adhesive structure with micro-undercuts which are cast with the silicone part and form a micromechanical positive fit between the silicone part and the intermediate element.

2. The arrangement for joining as claimed in claim 1, characterised in that the first surface is cast in a fluid-tight manner with the silicone part.

3. The arrangement for joining as claimed in claim 1, characterised in that the intermediate element is bonded on the second surface to a flexible or rigid adhesible part.

4. The arrangement for joining as claimed in claim 1, characterised in that the first surface has microstructural projections forming micro-undercuts.

5. The arrangement for joining as claimed in claim 1, characterised in that the first surface has microstructural indentations forming micro-undercuts.

6. The arrangement for joining as claimed in claim 1, characterised in that the first surface comprises fabric or special knitted material, such as terry cloth, Velcro, suede, Kevlar or Armatex.

7. The arrangement for joining as claimed in claim 1, characterised in that the intermediate element consists of neoprene (chloroprene rubber), which may be coated with an adhesive layer of fabric or special knitted material to form the first surface.

8. The arrangement for joining as claimed in claim 1, characterised in that there are an average of at least 10, 100, 500, 1,000, 5,000 or 10,000 micro-undercuts per cm² arranged on the first surface.

9. The arrangement for joining as claimed in claim 1, characterised in that the silicone part and the intermediate element and optionally the adhesible part are sewn together.

10. The arrangement for joining as claimed in claim 1, characterised in that the silicone part is a silicone sealing collar.

11. An arrangement for joining a silicone part to an intermediate element which is joined on a first surface to the silicone part and is bondable on a second surface to an adhesible part, the first surface having an adhesive structure with micro-undercuts which are cast with the silicone part and form a micromechanical positive fit between the silicone part and the intermediate element, for the creation of an arrangement for joining as claimed in claim 1.

12. A method for joining a silicone part to an intermediate element which is joined on a first surface to the silicone part and is bondable on a second surface to an adhesible part, the first surface having an adhesive structure with micro-undercuts which are cast with the silicone part, thus forming a micromechanical positive fit between the silicone part and the intermediate element, for the creation of an arrangement for joining as claimed in claim 1.

13. The method as claimed in claim 12, characterised in that the intermediate element is bonded on the second surface to an adhesible part.

14. The arrangement for joining as claimed in claim 10, characterised in that the silicone sealing collar is for a drysuit for diving.
